(19) United States
(12) Patent Application Publication
(10) Pub. No.: US 2010/0116648 A1
(43) Pub. Date: May 13, 2010

(54) Hydrogen-oxygen mixed gas generator

(76) Inventor: Boo-Sung Hwang, Seong-nam-si (KR)

Correspondence Address: RICHARD F. JAWORSKI;Cooper & Dunham LLP, 30 Rockefeller Plaza, New York, NY, 10112, US

(21) Appl. No.: 12/590,328

(22) Filed: Nov. 5, 2009

(30) Foreign Application Priority Data
Nov. 7, 2008 (KR) 10-2008-0110360

(51) Int. Cl. B23H 7/14

(52) U.S. Cl. 204/230.8

(57) ABSTRACT

A hydrogen-oxygen mixed gas generator includes a metal thin walled tube having a certain inner diameter, an insulation tube inserted into an inner surface of the tube, an electrolyte plate unit composed of multiple electrolyte plates with multiple holes and loops with certain thickness a frontal cover provided on a front of the metal thin walled tube and which includes a frontal inlet formed at the bottom and a frontal outlet formed at a top, a frontal insulator which disconnects electricity between the frontal cover and the tube, a rear cover provided on a rear of the metal thin walled tube and which includes a the rear inlet at the bottom and a rear outlet at the top, a rear insulator which disconnect electricity between the rear cover and the tube and a heat-protective plate covered with multiple heat-protective pins, provided in the metal thin walled tube between the front and rear covers.

### REFERENCE TO RELATED APPLICATION

The present disclosure is based on and claims the benefit of Korean Patent Application No. 10-2008-0110360 filed on Nov. 7, 2008, the entire contents of which are herein incorporated by reference.

### BACKGROUND

1. Field of the Disclosure

The present disclosure relates to mixed gas generators and, more particularly, to hydrogen-oxygen mixed gas generators.

2. Description of the Background Art

A hydrogen-oxygen mixture mixed gas generator is to produce hydrogen and oxygen from electrolyzed water; direct electric current is transferred to water containing small amount of electrolytes placed in electrolytic cell with positive and negative electrodes producing hydrogen-oxygen mixed gas, the pollution-free energy source. The mixed gas produced has a molecular ratio of hydrogen and oxygen in 2:1, and hydrogen is generated on the surface of (−) electrode in a bubble form and oxygen on the surface of (+) electrode. Hydrogen and oxygen produced can be mixed and ignited. Also, the ignition of the gas mixture does not produce any pollutant, raising itself as the new eco-friendly energy source.

However, because the amount of hydrogen-oxygen produced is relatively small compared to the amount of electric current transferred to (−) and (+) electrodes, additional gas, such as propane gas, is added and combusted which would result in low economical efficiency.

### SUMMARY

A hydrogen-oxygen mixed gas generator includes a metal thin walled tube having a certain inner diameter, an insulation tube inserted into an inner surface of the tube, an electrolyte plate unit composed of multiple electrolyte plates with multiple holes and loops with certain thickness a frontal cover provided on a front of the metal thin walled tube and which includes a frontal inlet formed at the bottom and a frontal outlet formed at a top, a frontal insulator which disconnects electricity between the frontal cover and the tube, a rear cover provided on a rear of the metal thin walled tube and which includes a the rear inlet at the bottom and a rear outlet at the top, a rear insulator which disconnect electricity between the rear cover and the tube and a heat-protective plate covered with multiple heat-protective pins, provided in the metal thin walled tube between the front and rear covers.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram of a hydrogen-oxygen mixed gas generator according to an embodiment of the present disclosure;

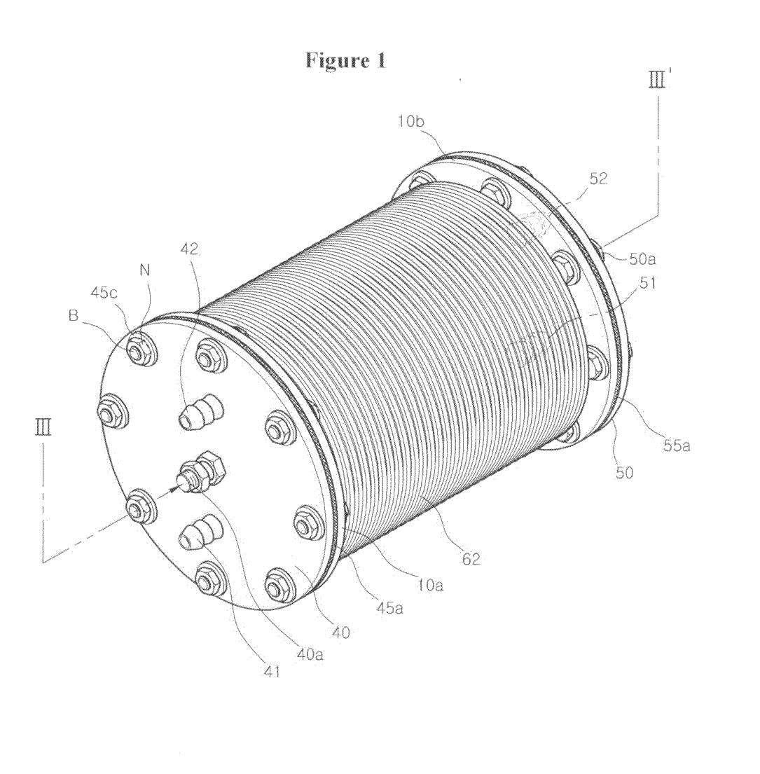

FIG. 2 is an exploded view of the hydrogen-oxygen mixed gas generator according to an embodiment of the present disclosure; and

FIG. 3 is a sectional view of the hydrogen-oxygen mixed gas generator of FIG. 1, taken along lines III-III.

### DETAILED DISCLOSURE

Embodiments of the present disclosure solve the above mentioned problems to provide an economical hydrogen-oxygen mixed gas generator by expanding the produced amount of hydrogen-oxygen mixture compared to the amount of electricity provided.

The hydrogen-oxygen generator produced to solve the above problem contains a caliber, a metal thin walled tube (10), an insulation tube (20) inside the thin walled tube (10), electrolyte plate unit (30) composed of multiple electrolyte plates (31) with multiple holes and loops with certain thickness (32) placed in the insulation tube (20) in alternative order; at the lower front for the thin walled tube (10), frontal cover (40) which contains frontal inlet (41) is formed and at upper front, frontal outlet (42); The frontal insulator (45) which disconnects electricity between the frontal cover (40) and the thin walled tube (10); the rear cover (50) containing rear inlet (51) at the lower rear of the thin walled tube (10) and rear outlet (52) at the upper rear of the thin walled tube; the rear insulator (55) to disconnect the electricity between the rear cover (50) and the thin walled tube (10); heat-protective plate (60) covered in multiple heat-protective pins (62).

According to the developed hydrogen-oxygen mixed gas generator, the thin walled tube with the insulator, the multiple electrolyte plates with multiple holes in the insulator, the front and rear covers at the front and rear of the thin walled tube, and the heat-protective plate in the insulator can increase the amount of hydrogen-oxygen mixed gas produced relative to the amount of electricity provided; therefore, the gas can be combusted without adding any additional gas, such as propane gas, increasing the economical efficiency.

Also, hydrogen and oxygen are formed in bubble forms, making them easy to remove from the electrodes. As a result, the surface area of the electrodes is enlarged, amplifying the electrolysis efficiency.

As shown, embodiments of the present disclosure contain a caliber, a metal thin walled tube (10), an insulation tube (20) inside the thin walled tube (10), electrolyte plate unit (30) composed of multiple electrolyte plates (31) with multiple holes and loops with certain thickness (32) placed in the insulation tube (20) in alternative order; at the lower front for the thin walled tube (10), frontal cover (40) which contains frontal inlet (41) is formed and at upper front, frontal outlet (42); The frontal insulator (45) which disconnects electricity between the frontal cover (40) and the thin walled tube (10); the rear cover (50) containing rear inlet (51) at the lower rear of the thin walled tube (10) and rear outlet (52) at the upper rear of the thin walled tube; the rear insulator (55) to disconnect the electricity between the rear cover (50) and the thin walled tube (10); heat-protective plate (60) covered in multiple heat-protective pins (62). The 1^{st} thermal conduction plate (70) is formed between the thin walled tube (10) and the insulator (20) to transfer the heat produced by electrolysis is effectively to the thin walled tube (10) through the insulator (20). The 2^{nd} thermal conduction plate (80) is also formed between the heat-protective plate (60) and the thin walled tube (10) to deliver the heat from the thin walled tube (10) to the heat-protective plate (60).

The thin walled tube (10) can be in any shape, circular, rectangular, hexagonal and so on, and can be formed by metals such as stainless or alloy steel. In the embodiments described above, the thin walled tube (10) is in a circular shape and has frontal and rear flanges (10a) (10b) on both sides. This tube (10) would be the body of the product.

The insulator (20), adhered inside the thin walled tube (10), insulates the insulator (20) and the electrolyte plate (30). The insulator is favorably composed of materials unaltered by water, such as Teflon rubber, acetal, or PP, PE substances.

In the product, the electrolyte plate (31) on the electrolyte unit (30) has separately formed upper holes (31a) and lower holes (31b) on the upper and lower side on the electrolyte plate. Also the loops (32) has same diameter as the electrolyte unit and the multiple electrolyte units are separated. In our example, the diameter for both components is 3 mm.

Above mentioned the upper holes (31a) and the lower holes (31b) reciprocally placed to each other and each form a cylinder on the electrolyte plates.

The electrolyte plate (31) should be made of material that can effectively perform electrolysis. An example would be carbon nanotube alloy steel. Carbon nanotube alloy steel is made from powered carbon nanotube mixed with nickel, tourmaline in powder form, and is compressed in electrolyte plate form before firing processes. At this phase of process, decarboxylase sodium compound can be added and the firing process is processed at about 1300°.

The electrolyte plate (31) can be formed by stainless steel and goes through nano-polishing to help electrolysis and separate produced hydrogen-oxygen bubbles. The electrolyte plate (31) is made of stainless steel or alloy steels.

Nano-polishing means polishing the surface of electrolyte plate (31) by nano-units. Through nano-polishing, the friction on the electrolyte plate (31) surface can be minimized, making hydrogen and oxygen bubbles to be easily separated. Especially when the substances decrease from bulk status to nano-unit, technical, thermal, electrical, magnetic, and optical properties are altered, making electrolysis on water easier.

Tourmaline catalyst can be attached on the surface of electrolyte plate (31). Tourmaline catalyst is made when tourmaline is powdered in to micro to nano-units, fired at about 1300° and glued on the electrolyte plate (31). Tourmaline is a mineral under hexagonal system that has same structure as crystal; it produces massive amount of anion and electricity through friction, and catalyzes the electrolysis resulting in greater amount in hydrogen and oxygen. The tourmaline is materialized as a catalyst the can expand its area to contact with water, and this tourmaline catalyst can catalyze the water's electrolysis by attaching it to the electrolyte plate (31).

The frontal cover (40) is jointed with frontal flange (10a) by the frontal insulator (45), bolts (B), and nuts (N) place on the thin walled tube (10). Water flows inward through the frontal inlet (41) at the lower part of the frontal cover (40) and hydrogen-oxygen mixed gas goes out through the frontal outlet (42) on the upper part of the frontal cover (40). Also, the terminal (40a) is formed on the frontal cover (40) to connect wires to turn the generator on and off.

The rear cover (40) is jointed with rear flange (10b) by the rear insulator (55), bolts (B), and nuts (N) place on the thin walled tube (10). Water flows inward through the rear inlet (51) at the lower part of the rear cover (50) and hydrogen-oxygen mixed gas goes out through the rear outlet (52) on the upper part of the rear cover (40). Also, the terminal (40b) is formed on the rear cover (50) to connect wires to turn the generator on and off.

The frontal and rear covers (40) (50) seals the both sides of the thin walled tube (10) and plays a negative and a positive poles. To accomplish these roles, frontal and rear covers (40) (50) each should be insulated with the metal thin walled tube (10), the frontal and the rear insulators, insulate the covers (40) (50), from the tube (10).

The frontal insulator (45), as drawn in diagram 2 and 3, includes frontal insulating gaskets (45a) between the frontal cover (40) and the frontal flange (10a), the multiple frontal insulating tubes (45b) in the tubes formed on the frontal cover (40) and frontal flange (10a), and the frontal insulating loop (45c) adhered to the frontal cover (40) and frontal flange (10a) by bolts (B) and nuts (N).

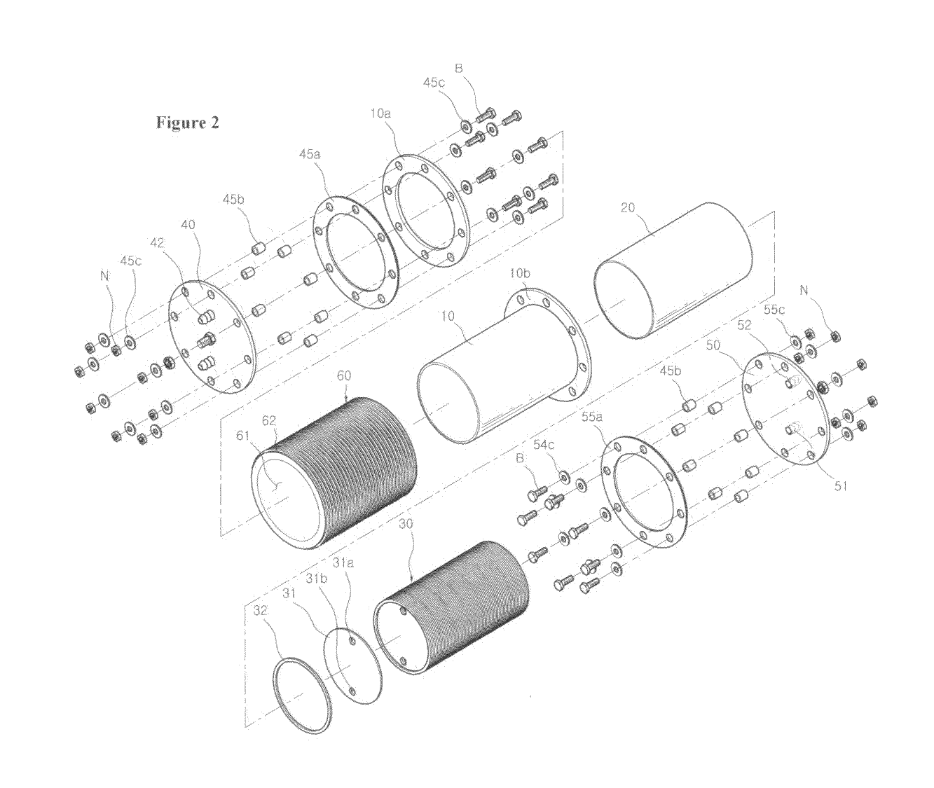

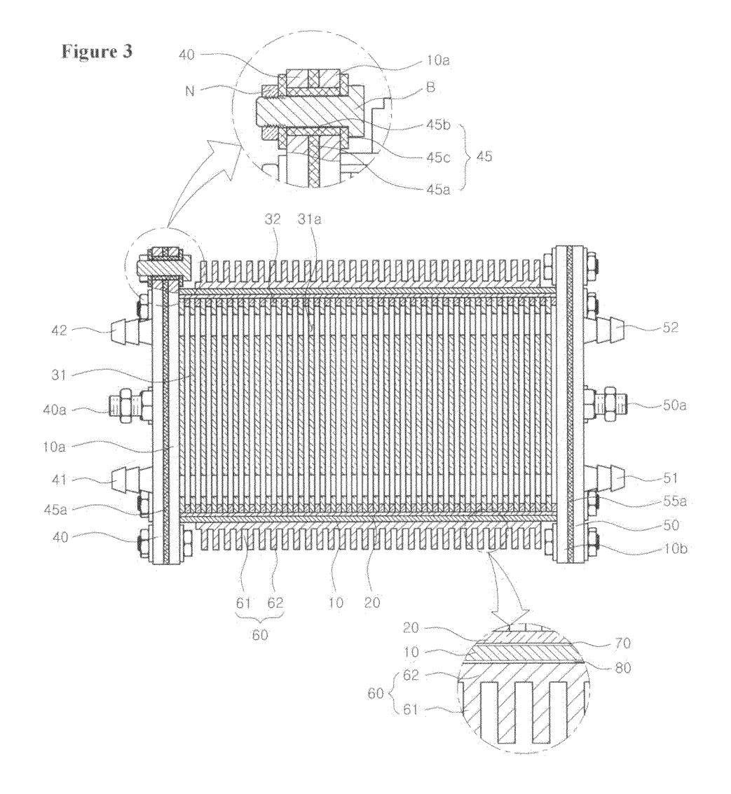

The rear insulator (55), as shown in FIGS. 2 and 3, includes rear insulating gaskets (55a) between the rear cover (50) and the rear flange (10b), the multiple rear insulating tubes (55b) in the tubes formed on the rear cover (50) and rear flange (10b), and the rear insulating loop (55c) adhered to the rear cover (50) and rear flange (10b) by bolts (B) and nuts (N).

The heat-protective plate (60) is composed of the heat-protective tube (61) on the thin walled tube (10) between the frontal and rear cover (40) (50) and the multiple heat-protective pins (62) placed on the heat-protective tube (61) separately. The heat-protective tube (61) and heat-protective pins (62) are made from whole aluminum tube or stainless tube processed by machines such as NC, castling, or by forming heat-resistant plastic or ceramic. However, in forming the heat-protective plate (60), the heat-protective tube (61) and heat-protective pins (62) can be made separately and combined later. Further, to increase the heat resistance, carbon nano-tube and tourmaline catalyst can be applied alone or together on the surface of heat-protective pins (62).

The 1^{st} thermal conduction plate (70) helps the heat produced through electrolysis can be delivered to the thin walled tube (10) through the insulator (20). The 2^{nd} thermal conduction plate (80) helps the transferred heat to the thin walled tube (10) can be conducted to the heat-protective plate (60). To go through these steps, the 1^{st} and 2^{nd} thermal conduction plates are materialized by carbon nano-tube and tourmaline catalyst in nanometer size, preferably 10-60 nanometer, are applied alone or together.

According to the structure, if more than 200V of electric current is injected to the terminals (40a) (50a) on frontal and rear cover (40) (50) while the water flows inward through the frontal inlet 941) and the rear inlet (51), then the + and − electric charges on separated electrolytic plates (31) come together and the magnetic field occurs on the electrolytic plate (31). The electrolyzing space at the time is magnetic, so the size of the electrolyzing space will enlarge relative to the number of the electrolyte plate (31), which would electrolyze effectively, producing more hydrogen and oxygen. The hydrogen and oxygen produced is mixed and exhausted through upper holes (31b) and front and rear outlets (42) (52).

Embodiments of the present disclosure are explained by reference to the accompanying figures. Of course, the figures are examples, and anyone with appropriate knowledge in the field would understand that there can be many variations that may apply.

The following list identifies various elements depicted in the Figures:
10—Thin walled tube
10a—frontal flange
10b—rear flange
20—Insulator
30—Electrolyte unit
31—Electrolyte plate
32—Separated loops
40—Frontal cover
41—Frontal inlet
42—Frontal outlet
45—Frontal insulator
45a—frontal insulating gasket
45b—frontal insulating tube
45c—frontal insulting ring
50—Rear cover
51—Rear inlet
52—Rear outlet
55—Rear insulator
55a—rear insulating gasket
55b—rear insulating tube+
55c—rear insulting ring
60—heat-protective plate
61—heat-protective tube
62—heat-protective pin
70—1^{st} thermal conduction plate
80—2^{nd} thermal conduction plate

What is claimed is:

1. A hydrogen-oxygen mixed gas generator comprising:
a metal thin walled tube having a certain inner diameter;
an insulation tube inserted into an inner surface of the tube;
an electrolyte plate unit composed of multiple electrolyte plates with multiple holes and loops with certain thickness;
a frontal cover provided on a front of the metal thin walled tube and which includes a frontal inlet formed at the bottom and a frontal outlet formed at a top;
a frontal insulator which disconnects electricity between the frontal cover and the tube;
a rear cover provided on a rear of the metal thin walled tube and which includes a the rear inlet at the bottom and a rear outlet at the top;
a rear insulator which disconnect electricity between the rear cover and the tube; and
a heat-protective plate covered with multiple heat-protective pins, provided in the metal thin walled tube between the front and rear covers.

2. The Hydrogen-oxygen mixed gas generator as recited in claim 1, further comprising:
a first thermal conduction plate provided between the tube and the insulator; and
a second thermal conduction plate provided between the tube and the heat-protective plate.

3. The Hydrogen-oxygen mixed gas generator as recited in claim 2, wherein the first and second thermal conduction plates can be used by applying nano-meter sized carbon nano-tube and tourmaline catalyst each or together.

4. The Hydrogen-oxygen mixed gas generator as recited in claim 1, wherein
the frontal insulator includes frontal insulating gaskets between the frontal cover and a frontal flange, the multiple frontal insulating tubes in the tubes formed on the frontal cover and frontal flange, and in front of the frontal cover and in the rear of the frontal flange, and wherein a frontal insulating loop is mounted to the frontal cover and frontal flange by bolts and nuts; and
the rear insulator includes rear insulating gaskets between the rear cover and the rear flange, the multiple rear insulating tubes in the tubes formed on the rear cover and rear flange, and wherein a rear insulating loop is mounted to the rear cover and rear flange by bolts and nuts.

5. The Hydrogen-oxygen mixed gas generator as recited in claim 1, wherein the heat-protective plate comprises a heat-protective tube on the tube between the frontal and rear covers and multiple heat-protective pins separately placed on the heat-protective tube.

6. The Hydrogen-oxygen mixed gas generator as recited in claim 5, further comprising nano-meter sized carbon nano-tube and tourmaline catalyst each or together applied on a surface of the heat-protective pins.

7. The Hydrogen-oxygen mixed gas generator as recited in claim 1, wherein the electrolyte plates are made of carbon nanotube alloy steel.

8. The Hydrogen-oxygen mixed gas generator as recited in claim 1, wherein a surface of the electrolyte plates is nano-polished to help electrolysis and to separate produced hydrogen-oxygen bubbles.

9. The Hydrogen-oxygen mixed gas generator as recited in claim 1, wherein a Tourmaline catalyst is attached on a surface of the electrolyte plate.
